(19) United States
(12) Patent Application Publication
(10) Pub. No.: US 2008/0279809 A1
(43) Pub. Date: Nov. 13, 2008

(54) COATING MATERIAL FOR METAL SURFACES HAVING ANTIADHESIVE PROPERTIES

(76) Inventors: Karsten Hackbarth, Duesseldorf (DE); Mirko Weide, Duesseldorf (DE); Juergen Stodt, Neuss (DE); Swapan Kumar Ghosh, Wichelen (BE)

Correspondence Address: HENKEL CORPORATION, 1001 TROUT BROOK CROSSING, ROCKY HILL, CT, 06067, US

(21) Appl. No.: 12/052,080

(22) Filed: Mar. 20, 2008

Related U.S. Application Data
(63) Continuation of application No. PCT/EP2006/008146, filed on Aug. 18, 2006.

(30) Foreign Application Priority Data
Sep. 22, 2005 (DE) 10 2005 045 441.0

(51) Int. Cl. A01N 43/20; C08L 63/00; A01P 1/00; C08F 2/46; B32B 15/08

(52) U.S. Cl. 424/78.32; 525/119; 427/496; 428/461

(57) ABSTRACT

A composition curable by polymerization, as well as a process of applying the composition and metal substrates coated therewith, the composition comprising: a) at least one metal compound which reacts before and/or during the curing of the composition by polymerization, with at least one of components b), c) or, if present, d), so that the metal is bound in the cured composition, the metal being selected from silicon, titanium, zirconium, manganese, zinc, vanadium, molybdenum and tungsten; b) at least one monomer or oligomer which contains at least one carboxyl or ester group and at least one olefinic double bond and which has no polyether chain of at least five ethylene oxide and/or propylene oxide units; c) at least one compound which contains both a polyether chain of at least five ethylene oxide and/or propylene oxide units and at least one carboxyl or ester group having at least one polymerizable double bond; and optionally d) at least one initiator for free radical and/or cationic polymerization and/or e) a biocidal active.

### CROSS-REFERENCE TO RELATED APPLICATIONS

This application is a continuation under 35 U.S.c. Sections 365(c) and 120 of International Application No. PCT/EP2006/008146, filed Aug. 18, 2006, and published as WO 2007/033736, which claims priority from German Application No. 10 2005 045 441.0 filed Sep. 22, 2005, which is incorporated herein by reference in its entirety.

### FIELD OF THE INVENTION

The present invention relates to a chromium-free organic/organometallic corrosion inhibitor and a corrosion inhibition method for the treatment of surfaces of steel, which are optionally provided with a metallic coating of zinc, aluminium, copper, nickel, etc, or of zinc, aluminium and their alloys. It is particularly suitable surface treatment in strip coating lines (coil-coating) for the use of these substrates in the household and architectural sector and in the automotive industry. The substrates coated with the corrosion inhibitor according to the invention may be used without further overcoating, in particular for components which, owing to their field of use, are susceptible to colonization by microorganisms. Specific examples of this are heat exchanger surfaces and air ducts of air conditioning systems. Here, condensing moisture and organic substances in the air form a good culture medium for microorganisms. Metabolic products of these microorganisms can lead to annoying odours. Infectious microorganisms which are spread by means of the air stream can cause diseases. The treatment of the metal surfaces with an agent according to the invention makes the adhesion of the microorganisms and hence the population of these surfaces more difficult. This reduces or prevents annoying odours and the risk of infection.

### BACKGROUND OF THE INVENTION

DE 197 51 153 describes polymerizable chromium-free organic compositions containing titanium, manganese and/or zirconium salts of olefinically unsaturated polymerizable carboxylic acids and further olefinically unsaturated comonomers and an initiator for free radical polymerization and the use thereof for organic coil coating of metallic materials. These nonaqueous polymerizable compositions permit a chromium-free pretreatment of steel materials having corrosion inhibition properties.

WO 00/69978 describes a chromium-free corrosion inhibitor containing at least one titanium, silicon and/or zirconium compound of the general formula (I)

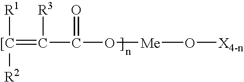

in which R¹ and/or R² is H, C₁- to C₁₂-alkyl, aralkyl or the group —CO—O—Y,
R³ is H or C₁- to C₁₂-alkyl,
Me is a titanium, silicon or zirconium ion,
X is H, C₁- to C₁₂-alkyl, aryl or aralkyl, alkoxyl, aroxyl, sulphonyl, phosphate or pyrophosphate,
Y is H, C₁- to C₁₂-alkyl or Me, and n is 0 to 4,
at least one further olefinically unsaturated comonomer having at least two olefinically unsaturated double bonds per molecule,
optionally further comonomers having one olefinically unsaturated double bond per molecule, at least one initiator for free radical and/or cationic polymerization.

The coatings described above serve for corrosion inhibition. They contain no active substances which prevent or impede population with microorganisms.

To make it more difficult for microorganisms to populate surfaces, it is known that substances having a biocidal action can be incorporated into the coating. For example, DE 103 41 445 describes an antimicrobial antifingerprint coating. There, nanoparticulate silver is incorporated into a coating material which is especially suitable for the coil coating method. Such biocidally treated coatings make it more difficult for microorganisms to populate the surfaces by killing deposited microorganisms. However, there is the danger that, as a result of the microbicidal active substance being leached out, firstly the efficiency declines in the course of time and secondly the microbicidal active substance undesirably enters the environment.

Population of surfaces with microorganisms can also be made more difficult by preventing or at least impeding the adhesion of the microorganisms to the surfaces. This can occur as a result of applying polyethylene glycol/polyacrylic acid polymers to the surfaces or incorporating such polymers into the material which forms the surface. For example, Patent Abstracts of Japan mentions, for the Japanese Patent Application with the publication No. 60/170,673, a coating material for materials such as, for example, ships, which are in contact with water. This coating material is obtained by copolymerization of a polymerizable unsaturated carboxylic acid, of a hydrophobic polymerizable unsaturated monomer and of polyethylene glycol (meth)acrylate. WO 03/055611 and U.S. Pat. No. 5,863,650, too, disclose that polymerizable polyethylene glycol carboxylates can be applied as an antiadhesive coating or can be incorporated into coatings in order to impart antiadhesive properties for microorganisms to said coatings.

### SUMMARY OF THE INVENTION

It is the object of the present invention to provide a coating material for metal surfaces which
1. is suitable for application in the coil coating method,
2. is heat-curable or curable by the action of high-energy radiation, such as, for example, UV radiation,
3. produces sufficient corrosion inhibition at a coating thickness of not more than 20 μm, preferably not more than 10 μm, the coating with the agent being the only corrosion inhibition measure,
4. impedes colonization of the coated surfaces by microorganisms.

The present invention relates, in a first aspect, to a composition which is heat-curable or curable by the action of radiation through polymerization and intended for the coating of metallic materials, containing:

a) at least one metal compound which reacts before and/or during the curing of the composition by polymerization with at least one of the components b), c) or, if present, d), so that the metal is bound in the cured composition, the metal being selected from: silicon, titanium, zirconium, manganese, zinc, vanadium, molybdenum and tungsten,
b) in addition to component a), at least one monomer or oligomer which contains at least one carboxyl or ester group and at least one olefinic double bond and which has no polyether chain of at least five ethylene oxide and/or propylene oxide units,
c) at least one compound which contains both a polyether chain of at least five ethylene oxide and/or propylene oxide units and at least one carboxyl or ester group having at least one polymerizable double bond, preferably a fumarate, maleate, crotonate, acrylate or methacrylate group.

The composition according to the invention which is curable by polymerization may be, for example, heat-cured or cured by the action of gamma radiation or electron beams. In this case, it is not necessary for it to additionally contain a polymerization initiator. If the coating material according to the invention is such that it can be cured by the action of electromagnetic radiation in the visible or in the UV range, it preferably additionally contains at least one initiator for free radical and/or cationic polymerization as component d).

During curing, components b) and c) form the organic network for coating as a result of polymerization, for example, due to the action of radiation. Component a) is bound in this network by chemical bonding at the latest during curing and thus remains firmly bonded to the network. This bound component a) is essential for the corrosion-inhibiting properties of the coating. The metal is preferably chosen from titanium, zirconium or a mixture of these two metals. The metal compound a) is present in the complete coating agent in a form in which it either itself has a polymerizable carbon-carbon double or triple bond which also reacts during the polymerization reaction of the components b) and c), or the metal compound a) is present in a form in which it can react with the acid groups of the components b) or c) and in this way is bound in the polymeric network.

### DETAILED DESCRIPTION OF THE INVENTION

Examples of metal compounds a), which can react with carboxyl groups of the components b), c) or, if present, d) and in this way are bound in the polymeric network of the components b) and c) during polymerization, are metal compounds which contain at least one acetylacetonate, alcoholate, thiolate, amino or amido group bonded to the metal. Owing to their ready availability and owing to the fact that they have little odour, metal compounds having acetylacetonate or alcoholate groups bonded to the metal are preferred.

Instead of or in addition to the groups described directly above, the metal compound a) may also contain at least one organic group bonded to the metal, preferably an organic acid group, which has at least one polymerizable C═C double bond or C≡C triple bond. This organic acid group may be, for example, an acid group of one of the components b), c) or, if present, d). These may form spontaneously if metal component a) used is a compound having acetylacetonate, alcoholate, thiolate, amino or amido groups which are bonded to the metal and can be replaced during or after mixing by carboxyl groups of at least one of the components b), c) or, if present, d). Such a conversion can be consciously brought about during the preparation of the coating material by heating. In this conversion reaction, the acetylacetonate, alcoholate, thiolate, amino or amido groups originally bonded to the metal may be eliminated as (volatile) alcohols, thiols, amines, amides or acetylacetone. These may act as diluents for the coating material and may advantageously influence the viscosity required for the application of the coating material to the metal surface. In this respect, it may be desirable for these eliminated molecules to remain in the coating material. On the other hand, they are volatile components which must be evaporated off during curing of the coating material. Alternatively, these volatile compounds can be removed by heating and/or evacuation during or after the mixing together of the complete coating material before the application of the coating material to the metal surface.

The metal compound a) can, for example, be selected from compounds of the general formula (II)

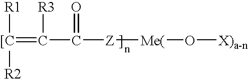

in which R¹ and R² may, each independently, be H, C₁- to C₁₂-alkyl, aralkyl or the group —CO—O—Y;
R³ may be H or C₁- to C₁₂-alkyl;
Me is a metal atom having an oxidation state “a”, and may be selected from silicon, titanium, zirconium, manganese, zinc, vanadium, molybdenum and tungsten;
X may be H, C₁- to C₁₂-alkyl, aryl, aralkyl, alkoxyl or aroxyl or 2(-O—X) may be acetylacetonate;
Y may be H, C₁- to C₁₂-alkyl or a further metal ion Me;
Z is selected from O, NH₂, a group O-Z^{b}-C(═O)—O, a group O-Z^{b}-P(═O)—O, a group O-Z^{b}-P(═O)₂—O, a group O-Z^{b}-O—P(═O)—O, a group O-Z^{b}-O—P(═O)₂—O, a group O-Z^{b}S(═O)₂—O, a group O-Z^{b}-O—S(═O)₂—O, where Z^{b} represents an organic group;
and n is 0 to a, preferably 1 to (a−1), a denoting the oxidation state of the metal Me in the group “-Me(-OX)ₐ₋ₙ”.

The group in square brackets in the general formula (II) represents an organic acid group which has a polymerizable C═C double bond. If n in the formula (II) is greater than 0, the metal compound can be bound in the polymeric network by reaction of this double bond in the polymerization of the components b) and c). On the other hand, the groups —O—X of the metal compound of the formula (II) can be replaced by acid groups of the components b), c) or, if present, d). This substitution reaction represents a further mechanism to enable the metal Me to be bound in the polymeric organic network.

The organic acid radical indicated by the square brackets of the formula (II) may correspond to the component b) or c), so that formula (II) can represent a (partial) reaction product of a metal compound Me(—O—X) a with component b) or c). As already mentioned above, such (partial) reaction products can form by themselves in the preparation of the composition from components a), b) and c). In this case, it is to be expected that the composition contains different metal compounds a) of formula (II) which differ by the numerical value of n. For steric reasons, it is to be expected that n does not assume the value of a in the formula (II), i.e. the groups (—O—X) in the metal compound are not completely replaced by the acid groups of the square brackets. In the ready-to-use composition, n is as a rule greater than 0 and preferably at least 1, but not greater than (a−1).

In the general formula (II), “a” denotes the oxidation state of the metal Me. As a rule, the metals are present in the metal compound a) in their oxidation state which is most stable under atmospheric conditions. In other words, “a” is as a rule equal to 4 for the metals silicon, titanium and zirconium, is equal to 2 or equal to 4 for manganese, is equal to 2 for zinc, is equal to 5 for vanadium and is equal to 4 or equal to 6 for molybdenum and tungsten.

In the simplest case, Z in the general formula (II) denotes oxygen, i.e. the group in the square brackets represents an unsaturated carboxyl group. However, as indicated above, Z may have a complex structure and may in turn contain a complete carboxylate group or a phosphorus- or sulphur-containing acid group. In these cases, the fragment Z in turn contains an organic bridge group Z^{b}. This bridge group is then preferably selected from linear or branched alkylene groups, preferably a linear alkylene group (CH₂)ₓ, where x is a number in the range from 1 to 10, in particular in the range from 2 to 4, (CHR⁴—CHR⁴—O—)_{y}CHR⁴—CHR⁴, where each R⁴, independently of one another, is in each case H or CH₃, and y being 0 or a number in the range from 1 to 9;

(CH₂)ₓ—O—C(═O)—(CH₂)_{y}, where x and y, each independently of one another, is a number in the range from 1 to 10, in particular in the range from 2 to 4;

The radicals R¹, R² and/or R³ of the general formula (II) can, as indicated further above, not only represent H but more complex radicals. However, it is preferable if, in the general formula (II), at least one, preferably at least two and in particular all three of the radicals R¹, R² and R³, independently of one another, are selected from H, CH₃, C₂H₅, C₃H₇ and C₄H₉. In the case of a propyl or butyl group, these may be present as the n- or i-isomer.

Specific examples of the titanium, silicon and/or zirconium compounds to be used according to the invention as metal compound a) are the following compounds: isopropyl dimethacryloylisostearoyltitanate, isopropyl tri(dodecyl)benzenesulphonyltitanate, isopropyl tri(octyl)phosphatotitanate, isopropyl (4-amino)benzenesulphonyldi(dodecyl)benzenesulphonyl titanate, alkoxyl trimethacryloyltitanate, isopropyl tri(dioctyl)pyrophosphatotitanate, alkoxytriacryloyl titanate, isopropyl tri(N-ethylenediamino)ethyl-titanate, di(cumyl)phenyloxoethylene titanate, di(dioctyl)pyrophosphatooxoethylenetitanate, dimethyl oxoethylenetitanate, di(butylmethyl)pyrophosphato-oxoethylenedi(dioctyl)phosphitotitanate, di(dioctyl)phosphatoethylenetitanate, di(butylmethyl)pyro-phosphatoethylenetitanate, tetraethyl titanate, tetraisopropyl titanate, tetra-n-propyl titanate, tetra-n-butyl titanate, n-butyl polytitanate, tetra-2-ethylhexyl titanate, tetraisooctyl titanate, isostearoyl titanate, monomeric cresyl titanate, polymeric cresyl titanate, octylene glycol titanate, titanyl acetylacetonate, diisopropoxybisethylaceto-acetatotitanate, di-n-butoxybisethylacetoacetato-titanate, diisobutoxybisethylacetoacetatotitanate, triethanolamine titanate, isopropyl triisostearoyl-titanate, adducts of 2-(N,N-dimethylamino)isobutanol, triethylamine, (meth)acrylate-functionalized amine derivative, methacrylamide-functionalized amine derivative with di(dioctyl)phosphatoethylenetitanate, tetraisopropyl di(dioctyl)phosphitotitanate, tetraoctyl di(ditridecyl)phosphitotitanate, tetra(2,2-diallyl-oxymethyl)butyl di(ditridecyl)phosphitotitanate, neopentyl(diallyl)oxytrineodecanoyltitanate, neopentyl (diallyl)oxytri(dodecyl)benzenesulphonyltitanate, neopentyl(diallyl)oxytri(dioctyl)phosphatotitanate, neopentyl(diallyl)oxytri(dioctyl)pyrophosphato-titanate, neopentyl(diallyl)oxytri(N-ethylenediamino)-ethyl titanate, neopentyl(diallyl)oxytri(m-amino)-phenyl titanate, neopentyl(diallyl)oxytrihydroxy-caproyltitanate, cyclo(dioctyl)pyrophosphatodioctyl titanate, dicyclo(dioctyl)pyrophosphatotitanate, 2-(acryloyloxyethoxy)trimethylsilane, N-(3-acryloyloxy-2-hydroxypropyl)-3-aminopropyltriethoxysilane, (3-acryloyloxypropyl)dimethylmethoxysilane, (3-acryloyl-oxypropyl)methylbis(trimethylsilyloxy)silane, (3-acryloyloxypropyl)methyldimethoxysilane, (3-acryloyl-oxypropyl)trimethoxysilane, (3-acryloyloxypropyl)tris-(trimethylsilyloxy)silane, acryloyloxytrimethylsilane, 1,3-bis((acryloyloxymethyl)phenethyl)tetramethyl-disiloxane, bis(methacryloyloxy)diphenylsilane, 1,3-bis(3-methacryloyloxypropyl)tetrakis(trimethylsilyl-oxy)disiloxane, 1,3-bis(3-methacryloyloxypropyl)-tetramethyldisiloxane, 1,3-bis(methacryloyloxy)-2-trimethylsilyloxypropane, methacryloylamidopropyl-triethoxysilane, methacryloylamidotrimethylsilane, methacryloyloxyethoxytrimethylsilane, N-(3-meth-acryloyloxy-2-hydroxypropyl)-3-aminopropyltriethoxy-silane, (methacryloyloxymethyl)bis(trimethylsilyloxy)-methylsilane, (methacryloyloxymethyl)dimethylethoxy-silane, (methacryloyloxymethyl)phenyldimethylsilane, methacryloyloxymethyltriethoxysilane, methacryloyloxy-methyltrimethoxysilane, methacryloyloxymethyltrimethyl-silane, methacryloyloxymethyltris(trimethylsilyloxy)-silane, O-methacryloyloxy(polyethyleneoxy)trimethyl-silane, 3-methacryloyloxypropylbis(trimethylsilyloxy)-methylsilane, 3-methacryloyloxypropyldimethylethoxy-silane, methacryloyloxypropyldimethylmethoxysilane, methacryloyloxypropylmethyldiethoxysilane, methacryloyloxypropylmethyldimethoxysilane, meth-acryloyloxypropylpentamethyldisilane, methacryloyloxypropylsilatrane, methacryloyloxypropyl-triethoxysilane, methacryloyloxypropyltrimethoxysilane, methacryloyloxypropyltris(methoxyethoxy)silane, methacryloyloxypropyltris(trimethylsilyloxy)silane, methacryloyloxypropyltris(trimethylsilyloxy)silane, methacryloyloxypropyltris(vinyldimethylsilyloxy)silane, methacryloyloyoxytrimethylsilane, tetrakis(2-meth-acryloyloxyethoxy)silane, Zr hexafluoropentanedionate, Zr isopropoxide, Zr methacryloylethylacetoacetate tri-n-propoxide, Zr 2-methyl-2-butoxide, Zr 2,4-pentanedionate, Zr n-propoxide, Zr 2,2,6,6-tetramethyl-3,5-heptanedionate, Zr trifluoropentanedionate, Zr trimethylsiloxide, dicyclopentadienylzirconium diethoxide, Zr 2-ethylhexanoate, Zr methacrylate, Zr dimethacrylate.

An individual compound or—preferably—a mixture of different compounds which, each by itself corresponds to the definition of component b) given above may be present as component b). The monomer or oligomer of the group b) is preferably selected from acrylic acid, methacrylic acid, crotonic acid, vinylacetic acid, maleic acid, fumaric acid and from monomers or oligomers which have at least one such acid group, it being possible for all or some of the carboxyl groups to be esterified.

The monomer or oligomer of group b) can in particular be selected from aromatic or aliphatic urethane acrylate or urethane methacrylate oligomers and adducts or copolymers of acrylic acid or methacrylic acid or hydroxyalkyl derivatives thereof with unsaturated dicarboxylic acids or with anhydrides of polybasic carboxylic acids or derivatives thereof. Examples of said unsaturated dicarboxylic acids are maleic acid and fumaric acid. A special anhydride of polybasic carboxylic acids is succinic anhydride.

Preferably, at least a part of component b) is an olefinically unsaturated comonomer having at least 2 olefinically unsaturated double bonds per molecule. Suitable comonomers having at least 2 olefinically unsaturated double bonds per molecule include a large number of comonomers, for example esterification products of alkanepolyols, polyesterpolyols or polyetherpolyols with olefinically unsaturated carboxylic acids, such as, for example, acrylic acid, methacrylic acid, itaconic acid, crotonic acid, maleic acid, maleic monoesters, fumaric acid, fumaric monoesters or reactive macromonomers containing carboxyl groups or mixtures thereof. (Meth)acrylate-functional polysiloxanes, (meth)acrylate-functional aliphatic, cycloaliphatic and/or aromatic polyepoxides and polyurethane compounds having reactive (meth)acrylate groups are furthermore suitable as comonomers having at least 2 reactive double bonds per molecule. Typically, the abovementioned comonomers having at least 2 olefinically unsaturated double bonds per molecule have molecular weights in the range from 600 to 50,000, preferably between 1000 and 10,000.

Specific examples of alkanepolyols are 1,4-butanediol, 1,6-hexanediol, 1,8-octanediol and the higher homologues thereof, glycerol, trimethylolpropane, pentaerythritol and the alkoxylation products thereof.

Furthermore, the liquid polyesters which can be prepared by condensation of di- or tricarboxylic acids, such as, for example, adipic acid, sebacic acid, glutaric acid, azelaic acid, suberic acid, 3,3-dimethylglutaric acid, terephthalic acid, isophthalic acid, hexahydrophthalic acid or dimeric fatty acids with low molecular weight diols or triols, such as, for example, ethylene glycol, propylene glycol, diethylene glycol, triethylene glycol, dipropylene glycol, 1,4-butanediol, 1,6-hexanediol, 1,10-decanediol, dimeric fatty alcohol, glycerol or trimethylolpropane, are suitable as polyols.

A further group of the polyol building blocks to be used according to the invention are the polyesters based on α-caprolactone, also referred to as “polycaprolactones”. However, it is also possible to use polyesterpolyols of oleochemical origin. Such polyesterpolyols can be prepared, for example, by complete ring opening of epoxidized triglycerides of an at least partly olefinically unsaturated fatty acid-containing fat mixture with one or more alcohols having 1 to 12 C atoms and subsequent partial transesterification of the triglyceride derivatives to give alkyl ester polyols having 1 to 12 C atoms in the alkyl radical. Further suitable polyols are polycarbonatepolyols and dimeric diols and castor oil and derivatives thereof. The hydroxy-functional polybutadienes, which are obtainable, for example, under the trade name “Poly-bd”, can also be used as polyols for the compositions according to the invention.

Also suitable for the present invention are one or more of the polyurethane compounds (A), (B) and/or (C) which are capable of undergoing free radical polymerization and are of the general formula (III):

(H₂C═CR¹—C(═O)—O—R²—O—C(═O)—NH—)ₙR³ (III)

in which
R¹ is hydrogen or a methyl group;
R² is a linear or branched alkyl group having 2 to 6 carbon atoms or alkylene oxide having 4 to 21 carbon atoms;
n is 1, 2 or 3;
   (A) R³ for n=1 is:
an aryl group having 6 to 18 carbon atoms,
a straight-chain or branched alkyl group having 1 to 18 carbon atoms or
a cycloalkyl group having 3 to 12 carbon atoms;
   (B) R³ for n=2 is:

[-Q-NH—C(═O)]₂](—O—R⁴—O—C(═O)—NH-Q′-NH—C(═O))ₘ—O—R⁴—O—]

where m is 0 to 10 and
R⁴ is
   a) a polycaprolactonediol radical,
   b) a polytetrahydrofurfuryldiol radical or
   c) a diol radical which is derived from a polyesterdiol and has a molecular weight of from 1000 to 20,000, or
      (C) R³ for n=3 is:

[-Q-NH—C(═O)—O—((CH₂)₅—C(═O))ₚ—]₃R⁵,
where R⁵ is a triol radical of a linear or branched trivalent alcohol containing 3 to 6 carbon atoms and p is 1 to 10 and
Q and Q′, independently of one another, are aromatic, aliphatic or cycloaliphatic groups which contain 6 to 18 carbon atoms and are derived from diisocyanates or diisocyanate mixtures.

Examples of suitable aromatic polyisocyanates are: all isomers of toluene diisocyanate (TDI), either in the form of a pure isomer or as a mixture of a plurality of isomers, naphthalene 1,5-diisocyanate, diphenylmethane 4,4′-diisocyanate (MDI), diphenylmethane 2,4′-diisocyanate and mixtures of diphenylmethane 4,4′-diisocyanate with the 2,4-isomer or mixtures thereof with higher-functional oligomers (so-called crude MDI), xylylene diisocyanate (XDI), diphenyldimethylmethane 4,4′-diisocyanate, di- and tetraalkyldiphenylmethane diisoocyanate, dibenzyl 4,4′-diisocyanate, phenylene 1,3-diisocyanate and phenylene 1,4-diisocyanate. Examples of suitable cycloaliphatic polyisocyanates are the hydrogenation products of the abovementioned aromatic diisocyanates, such as, for example, dicyclohexylmethane 4,4′-diisocyanate (H12MDI), 1-isocyanatomethyl-3-isocyanato-1,5,5-trimethylcyclohexane (isophorone diisocyanate, IPDI), cyclohexane 1,4-diisocyanate, hydrogenated xylylene diisocyanate (H6XDI), 1-methyl-2,4-diisocyanatocyclohexane, m- or p-tetramethylxylene diisocyanate (m-TMXDI, p-TMXDI) and dimeric fatty acid diisocyanate. Examples of aliphatic polyisocyanates are tetramethoxybutane 1,4-diisocyanate, butane 1,4-diisocyanate, hexane 1,6-diisocyanate (HDI), 1,6-diisocyanato-2,2,4-trimethylhexane, 1,6-diisocyanato-2,4,4-trimethylhexane, butane 1,4-diisocyanate and dodecane 1,12-diisocyanate (C₁₂CDI).

A large number of polyepoxides which have at least two 1,2-epoxy groups per molecule are suitable as epoxy resin building blocks for the olefinically unsaturated comonomers having at least two olefinically unsaturated double bonds per molecule. The epoxide equivalents of these polyepoxides may vary between 150 and 4000. The polyepoxides can in principle be saturated, unsaturated, cyclic or acyclic, aliphatic, alicyclic, aromatic or heterocyclic polyepoxide compounds. Examples of suitable polyepoxides include the polyglycidyl ethers which are prepared by reaction of epichlorohydrin or epibromohydrin with a polyphenol in the presence of alkalis. Polyphenols suitable for this purpose are, for example, resorcinol, pyrocatechol, hydroquinone, bisphenol A (bis(4-hydroxyphenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane and 1,5-hydroxynaphthalene. Further polyepoxides which are suitable in principle are the polyglycidyl ethers of polyalcohols or diamines. These polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane. Further polyepoxides are polyglycidyl esters of polycarboxylic acids, for example conversion of glycidol or epichlorohydrin with aliphatic or aromatic polycarboxylic acids, such as oxalic acid, succinic acid, glutaric acid, terephthalic acid or dimeric fatty acids. Further epoxides are derived from the epoxidation products of olefinically unsaturated cycloaliphatic compounds.

Specific examples for di-, tri- or polyfunctional (meth)acrylates to be used according to the invention are the following compounds: 1,3-butylene glycol di(meth)acrylate, 1,4-butanediol di(meth)acrylate, 1,6-hexanediol di(meth)acrylate, bisphenol A epoxide di(meth)acrylate, alkoxylated bisphenol A di(meth)acrylate, polyalkylene glycol di(meth)acrylate, trialkylene glycol diacrylate, tetraalkylene glycol di(meth)acrylate, neopentylglycol di(meth)acrylate, alkoxylated neopentyl glycol di(meth)acrylate, trialkylolalkane tri(meth)acrylate, alkoxylated trialkylolalkane tri(meth)acrylate, glycerol alkoxy tri(meth)acrylate, pentaerythrityl tri(meth)acrylate, tris(2-hydroxyalkyl)isocyanurate tri(meth)acrylate, tri(meth)acrylate compounds containing acid groups, trimethylolpropane tri(meth)acrylate, trisalkoxytrimethylolpropane tri(meth)acrylate, ditrimethylolpropane tetra(meth)acrylate, pentaerythrityl tetra(meth)acrylate, alkoxylated pentaerythrityl tetra(meth)acrylate, dipentaerythrityl penta(meth)acrylate, dipentaerythrityl hexa(meth)acrylate, “alkylene” denoting ethylene, propylene or butylene and “alkoxy” denoting ethoxy, 1,2- or 1,3-propoxy or 1,4-butoxy.

In addition, the following (meth)acrylate monomers may be concomitantly used: amine-modified polyetheracrylate oligomers, carboxy-functionalized polyfunctional (meth)acrylates, polyfunctional melamine acrylates, difunctional silicone acrylates.

The following (meth)acrylates can be concomitantly used as monofunctional comonomers: monomethacryloyloxyalkyl succinate, n-alkyl and isoalkyl(meth)acrylate, cyclohexyl(meth)acrylate, 4-tert-butylcyclohexyl(meth)acrylate, dihydrodicyclopentadienyl(meth)acrylate, tetrahydrofurfuryl(meth)acrylate, isobornyl (meth)acrylate (IBOA), α-carboxyethyl(meth)acrylate (α-CEA); mono(meth)acryloylalkyl phthalates, succinate and maleate; 2-(2-ethoxyethoxy)ethyl(meth)acrylate, 2-phenoxyalkyl(meth)acrylate, alkanediol mono(meth)acrylate, allyl(meth)acrylate, hydroxyalkyl (meth)acrylate, 2,3-epoxyalkyl(meth)acrylate, N,N-dialkylaminoalkyl (meth)acrylate, N,N-dialkyl(meth)acrylamide, monoalkoxytrialkyleneglycol (meth)acrylate, monoalkoxyneopentylglycol alkoxylate (meth)acrylate, polyalkylene glycol (meth)acrylate and alkoxylated nonylphenol (meth)acrylate, it being possible for the alkyl groups to have 1 to 12 C atoms, and “alkoxy” denoting ethoxy, 1,2- or 1,3-propoxy or 1,4-butoxy.

Particularly preferred examples of component b) are stated in the example section.

Compounds of group c) which have both a polyether chain comprising at least 5 ethylene oxide and/or propylene oxide units and at least one carboxyl or ester group having at least one polymerizable double bond give the composition cured by polymerization its antiadhesive properties with respect to microorganisms. The type and amount of component c) must be chosen such that firstly a sufficient antiadhesive effect with respect to microorganisms is achieved and secondly the cured coating has the required corrosion inhibition action. This is the case as a rule when the compound of group c) has a molar mass in the range from 250 to 2500, preferably in the range from 300 to 650. These are compounds having a polyethylene glycol and/or polypropylene glycol chain comprising at least 5 such units, in which a carboxyl radical having a least one polymerizable double bond is located at one or both chain ends. In general, the carboxyl radical is linked to the polyether chain by an ester bond.

Examples of component c) are compounds of the general formula (IV) or (V):

CHR¹═CR²—C(═O)—O—(CHR³—CHR³—O)ₙ—R⁴ (IV)

or

CHR¹═CR²—(CH₂)ₚ—C(═O)—O—(CHR³—CHR³—O)ₙ—R⁴ (V)

R¹ and R², independently of one another, can denote: H, an alkyl group having 1 to 12 C atoms, a —COOR⁵ group or a —(CH₂)_{q}—COOR⁵ group (with in each case R⁵═H or an alkyl group, preferably having 1 to 4 C atoms, and where q=1 to 4),
R³ in both cases can denote an H atom, or one of the two radicals R³ represents a methyl group and the other represents an H atom,
R⁴ can denote H, an alkyl group, preferably having 1 to 12 C atoms and in particular having 1 to 4 C atoms or a phenyl or benzyl group, which in each case in turn may carry an alkyl group, preferably having 1 to 12 C atoms, or R⁴ represents a further
CHR¹═CR²—C(═O) or CHR¹═CR²—(CH₂)ₚ—C(═O) group, i.e. the polyalkylene glycol chain O—(CHR³—CHR³—O)ₙ can be esterified at one end or at both ends with the unsaturated carboxylic acid,
n is by definition at least 5 and is preferably chosen so that the molar mass of component c) is in said preferred range,
p is a number in the range from 1 to 4.

Regarding the C═C double bond in the formulae (IV) and (V), the compounds may be present in the cis- or in the trans-form if R¹ is not an H atom.

In the formulae (IV) and (V), both R¹ and R² preferably denote H atoms, or one of these two radicals denotes an H atom and the other denotes a methyl group. In particular, the polyalkylene glycol chain O—(CHR³—CHR³—O)ₙ is preferably esterified at one end or at both ends with acrylic acid, methacrylic acid, maleic acid, fumaric acid, crotonic acid or isocrotonic acid or with vinylacetic acid, it being possible for the second carboxyl group of maleic acid and fumaric acid to be esterified in turn, preferably with an alcohol having 1 to 4 C atoms.

Specific examples of this can be found in the example section.

Component c) may be or may contain, for example, ethoxylated nonylphenol acrylate. Component c) may be an individual compound or a mixture of different compounds which, each by themselves, fulfil the definition of component c). Further examples are mentioned in the example section.

Component c) incorporated in the form of polymerized units in the cured coating imparts to said coating as a rule sufficient antiadhesive properties with respect to microorganisms. In addition, the presence of this component surprisingly improves the corrosion inhibition, as is evident from the working examples in comparison with the comparative examples. It is therefore advisable to use this component in addition to components a) and b) even when an antiadhesive effect is not important but when it is intended to achieve only a good corrosion inhibition effect.

Owing to the antiadhesive properties, the presence of component c) makes it more difficult for microorganisms to adhere to the coated surface. Here, microorganisms are to be understood in particular as meaning eukariotic monocellular organisms and protozoa, bacteria, fungi, viruses and algae. This also includes bacterial endo- or exospores and spores which serve as root production structures in fungi. In particular, microorganisms may be understood as meaning bacteria and fungi. Particularly important fungi here are yeasts, moulds, dermatophytes and keratinophilic fungi. In the widest sense, the term “microorganisms” also includes organic allergens, such as, for example, pollen, house dust, etc.

It may be advantageous additionally to treat the coating with a biocidally or biostatically active substance (subsumed under “biocidal active”). By means of this, microorganisms which adhere to the coating in spite of the antiadhesive properties can be killed or at least prevented from multiplying. The biocidal active is preferably chosen such that it is not leached out of the coating by moisture, for example by condensation, or is leached out of the coating only over very long periods. Firstly, this prevents the effect from declining too rapidly. Secondly, leaching out of the biocidal active would lead to “gaps” in the coating through which a corrosive attack may be facilitated.

This is taken into account by virtue of the fact that the composition according to the invention additionally contains, as component e), a biocidal active which preferably has little solubility in water at room temperature, in particular has a solubility of not more than 10 g/l, particularly not more than 1 g/l.

Microbicidal actives (algicides, fungicides, bactericides, virucides) are distinguished by the fact that they kill microorganisms, depending on their concentration and the temperature and time of action, by damaging the cell membrane or blocking metabolic processes essential to life, or result in the killing or destruction and the inhibition or control of the growth or of the multiplication of bacteria, fungi (including yeasts and moulds) and algae in dormant, immature stages of development and/or in the mature state and deactivate viruses. They thus inhibit the harmful effect of microorganisms. Examples are aldehydic actives, quaternary ammonium compounds and isothiazolone compounds. Specific examples of these and further examples of biocidal active substances are described in the Laid-Open Application WO 2004/049800 and the standard works cited there.

In one embodiment, the biocidal active is an organic compound which is bound in the cured coating. This requires compatibility of the organic compound with the polymer network of the cured coating. Examples of this are 10,10′-oxybisphenoxarsine, zinc omadine (manufacturer: Olin Chemicals), zinc trythione, N-(trichloromethylthio)phthalimide, 4,5-dichloro-2-n-octyl-4-isothiazolin-3-one, 2-n-octyl-4-isothiazolin-3-one, N-(trichloromethylthio)-4-cyclohexene-1,2-dicarboximide and 2,3,5,6-tetrachloro-4-(methyl-sulphonyl)pyridine.

In a further embodiment, the biocidal active is a particulate inorganic compound or a particulate metal. The mean particle size, which can be determined, for example, by electron microscopy or in particular by light scattering methods, should be not more than 50% greater than the intended thickness of the cured coating. For example, the mean particle size is less than 1 μm and is particularly preferably in the so-called nanoscale range, i.e. in the range below 900 nm and in particular below 500 nm. Examples of this are particulate, in particular nanoscale, zinc oxide or metallic silver.

In a further embodiment, the biocidal active contains biocidal metal ions, preferably selected from tin, zinc, copper and silver ions. In a further preferred embodiment, these may be bound to an organic or inorganic skeleton capable of cation exchange and may be exchangeable for alkali metal ions. Examples of inorganic skeletons to which the biocidal metal ions may be bound are particulate silicas, zeolites or zirconium phosphates. Silver-containing zeolites or silver-containing zirconium phosphates are particularly suitable. Furthermore, silver-containing glass spheres of appropriate particle size are suitable.

The compositions according to the invention are preferably cured by a UV or electron beam curing process. Depending on initiators and monomers used, this curing process can take place according to a free radical or cationic polymerization process.

Suitable initiators for this free radical or cationic polymerization (component d) are, for example, the following initiators: 1-hydroxycyclohexyl phenyl ketone, (5,2,4-cyclopentadien-1-yl)-[(1,2,3,4,5,6-)-(1-methylethyl)benzene]iron(1+)-hexafluorophosphate(1-), 2-benzyldimethylamino-1-(4-morpholinophenyl)butan-1-one, benzil dimethyl ketal dimethoxyphenylacetophenone, bis(5-2,4-cyclopentadien-1-yl)-bis[2,6-difluoro-3-(1H-pyrrol-1-yl)phenyl]titanium, bis(2,4,6-trimethyl-benzoyl)phenylphosphine oxide (BAPO2), 2-methyl-1-[4-(methylthio)phenyl]-2-morpholinopropan-1-one, 1-(4-(1-methylethyl)phenyl)-2-hydroxy-2-methyl-1-propan-1-one, 2-hydroxy-2-methyl-1-phenylpropan-1-one, 1,2-diphenylethane-1,2-dione, 1-[4-(2-hydroxyethoxy)-phenyl]-2-hydroxy-2-methyl-1-propan-1-one, (2,4,6-trimethylbenzoyl)diphenylphosphine oxide, hydroxybenzyl phenyl ketone, triarylsulphonium hexafluoroantimonate salts, triarylsulphonium hexafluorophosphate salts, oligo-(2-hydroxy-2-methyl-1-[4-(1-methylvinyl)phenyl]-propanone), 1-propanone-2-hydroxy-2-methyl-1-[4-(1-methylethenyl)phenyl]homopolymer, benzoylbis(2,6-dimethylphenyl)phosphonate, benzophenone, methyl ortho-benzoylbenzoate, methyl benzoylformate, 2,2-diethoxyacetophenone, 2,2-di-sec-butoxyacetophenone, [4-(4-methylphenylthio)phenyl]phenylmethanone-4-benzoyl-4′-methyldiphenyl sulphide, p-phenylbenzo-phenone, 2-isopropylthioxanthone, 2-methyl-anthraquinone, 2-ethylanthraquinone, 2-chloro-anthraquinone, 1,2-benzanthraquinone, 2-tert-butyl-anthraquinone, 1,2-benzo-9,10-anthraquinone, benzil, benzoin, benzoin methyl ether, benzoin ethyl ether, benzoin isopropyl ether, alpha-methylbenzoin, alpha-phenylbenzoin, Michler's ketone, benzophenone, 4,4′-bis(diethylamino)benzophenone, acetophenone, diethoxyphenylacetophenone, thioxanthone, diethyl-thioxanthone, 1,5-acetonaphthalene, ethyl p-dimethylaminobenzoate, benzil ketones, 2,4,6-trimethyl-benzoyldiphenylphosphine oxides, benzil ketal (2,2-dimethoxy-1,2-diphenylethanone), 1-hydroxycyclohexyl phenyl ketone, 2-methyl-1-[4-(methylthio)phenyl]-2-morpholinopropan-1-one and/or 2-hydroxy-2-methyl-1-phenylpropan-1-one and/or mixtures thereof. These can optionally be combined with further free radical initiators of the peroxide or azo type and/or with amine accelerators.

If cationic polymerization is to be used, vinyl ether can also be used as comonomers.

Examples of such vinylethers are vinyl methyl ether, vinyl ethyl ether, vinyl propyl ether, vinyl isobutyl ether, vinyl dodecyl ether, vinyl octadecyl ether, vinyl cyclohexyl ether, vinyl 4-hydroxybutyl ether, butane-1,4-diyl divinyl ether, 1,4-cyclohexane-dimethanol divinyl ether, diethylene glycol divinyl ether, triethylene glycol divinyl ether, but also the following vinyl compounds: N-vinylpyrrolidone, vinylcaprolactam, 1-vinylimidazole and divinylethyleneurea.

Specific examples of polymerization initiators are a mixture of 2-hydroxy-2-methyl-1-phenylpropanone with 1-hydroxyethylcyclohexyl phenyl ketone mentioned in the example section and bis(2,4,6-trimethylphenyl)-acylphenyl phosphine oxide.

The composition according to the invention preferably contains the components in the following proportions, based on the total composition:
component a): from 2 to 49.99, preferably from 7 to 35, % by weight,
component b): from 50 to 90% by weight,
component c): from 0.01 to 20, preferably from 0.1 to 10, in particular from 0.5 to 6, % by weight,
component d): from 0 to 10, preferably from 1 to 8, in particular from 2 to 6, % by weight,
component e): from 0 to 15, preferably from 0.5 to 12, % by weight.

The individual components a) to e) may in each case consist of a single compound or they may be mixtures of different compounds. The latter is in particular desirably the rule for component b) and component c). As explained further above, component a) may be present as a reaction product of an originally used metal compound with in particular one of components b) and c). Component a) is then as a rule likewise a mixture of different compounds.

If component a) contains no organic group which is bonded to the metal and has a polymerizable carbon-carbon double or triple bond, the proportion thereof in the composition is preferably from 2 to 20 and in particular from 5 to 15% by weight. This applies, for example, for the case where component a) is an alcoholate or an acetylacetonate of one of said metals. If, however, metal compound a) has at least one organic group bonded to the metal and having a polymerizable carbon-carbon double or triple bond, it may be present in a larger proportion, for example of up to 49.99% by weight and preferably from 7 to 35% by weight.

The person skilled in the art is familiar with the fact that the abovementioned components, in particular the organometallic compounds, can undergo reactions with one another and, as industrial products, may contain impurities, so that they are present in the treatment composition in the form which corresponds to the thermodynamic equilibrium under said conditions, if said equilibrium has already been established. The tables in the example section are to be understood in this sense. They indicate which raw materials were used in which amounts for the preparation of the composition according to the invention. It is to be expected that individual components react with one another on mixing the raw materials. For example, alcohols and carboxylic acids may combine to form esters. If it is desired, such a reaction can be brought about by heating the mixture during the preparation. This applies in particular to metal compound a) alcoholates, for example titanium tetraisopropoxylate. The alcoholate will react at least partly with further components of the mixture with elimination of the alcohol. The eliminated alcohol can remain in the product thereby reducing its viscosity. However, the resulting alcohol can also be removed by heating and/or evacuation if it is important that as little solvent as possible must evaporate during curing of the coating.

Furthermore, it is known to the person skilled in the art that product mixtures comprising molecules having different degrees of alkoxylation always form during the alkoxylation of alcohols or carboxylic acids. The skilled person therefore understands the statement of a degree of alkoxylation as meaning “average degree of alkoxylation”. This also applies to the ethoxylate mentioned in the example section.

The abovementioned components a) to e) preferably constitute the main amount of the agent according to the invention, i.e. their proportions preferably sum to at least 80% by weight and in particular to at least 90% by weight of the total composition. It is therefore preferable if the composition contains not more than 20% by weight and in particular not more than 10% by weight of further components. If desired, not more than 10% by weight, preferably not more than 5% by weight, based on the total composition, of further components may be present, which are preferably selected from adhesion promoters, in particular silanes, and corrosion inhibitors, preferably selected from the group consisting of: organic phosphates and phosphonates, silicates, in particular sheet silicates, alkoxysilanes and the hydrolysis products and condensates thereof. If sheet silicates are used, such as, for example, montmorillonites or talc, they are preferably used in nanoscale form, i.e. having a mean particle size below 1 μm. Alkoxysilanes which may be used are, for example, tetraalkoxysilanes, in particular tetraethoxysilane. With water absorption and elimination of alcohol, these can react to give silicas and condensates thereof.

Regardless of whether the composition additionally contains such adhesion promoters and corrosion inhibitors, it is furthermore preferable if the composition contains not more than 10% by weight, preferably not more than 5% by weight, of components such as, for example, diluents or solvents which are not incorporated into the resulting layer during curing by polymerization but instead have to be evaporated. In particular, it is preferable if the composition contains not more than 2% by weight of such components which are volatile during the curing. As explained further above, such volatile components can enter the composition if they form a constituent of component a) and are liberated during the preparation of the composition by reaction of component a) with components b) and/or c). This is the case, for example, if component a) is an alcoholate or an acetylacetonate of one of said metals. Alcohol or acetylacetone can be liberated therefrom by reaction with components b) and/or c) containing carboxyl groups. If the content of volatile components in the composition which is brought about in this manner exceeds the desired upper limits, it can be reduced to the preferred maximum amount by suitable technical measures, such as, for example, removal by heating and/or evacuation.

In a second aspect, the present invention relates to a method for the coating of metal strip, characterized in that a coating material according to the invention is applied in such a layer thickness to the moving metal strip and cured by irradiation with high-energy radiation, preferably with electron beams or with UV radiation, that, after curing, a cured layer having a thickness in the range from 1 to 10 μm, preferably from 2 to 6 μm, is obtained.

In this method, the composition is applied to a metal strip in a manner known per se by roll application (chem coating), application with a doctor blade, film casting (curtain flow method), dipping/squeezing off or spraying/squeezing off. The application is effected at temperatures between 10 and 60° C., preferably between 15 and 45° C.

The formation of the film, the crosslinking of this film and the anchoring to the metallic surface preferably take place by UV irradiation or electron irradiation known per se. The duration of irradiation is between 0.1 and 120 seconds, preferably between 0.5 and 30 seconds. If the treatment according to the invention is effected immediately after a metallic surface treatment, for example electrolytic galvanizing or hot dip galvanizing of steel strips, these strips can be brought into contact with the treatment solution or dispersion according to the invention without prior cleaning. If, however, the metal strips to be treated are stored and/or transported before coating according to the invention, they are as a rule provided with corrosion inhibition oils or are at least so substantially soiled that cleaning is required before the coating according to the invention. This can be effected with customary weakly to strongly alkaline cleaners and, in the case of aluminium and its alloys, also with acidic cleaners.

The compositions according to the invention are preferably cured or crosslinked by ultraviolet (UV) radiation or by electron beams. Suitable UV radiation has wavelengths between 200 and 800 nm, preferably between 250 and 450 nm. The radiation intensity depends on the desired application rate, the initiator system and the comonomer composition and can be readily determined by the person skilled in the art.

For the electron beams to be used as an alternative, any conventional electron beam source can be used. Accelerators of the van de Graaff generator, linear accelerator, resonance transformer or Dynatron type may be mentioned by way of example. The electron beam has an energy of from about 50 to 1000 keV, preferably between 100 and about 300 keV, and the resulting radiation dose is between about 0.1 and 100 Mrad.

The coating method according to the invention is preferably the only measure for the corrosion inhibition treatment of the metal surface. It is therefore not necessary for the metal strip surface to be subjected to another corrosion inhibition treatment before the application of the coating material according to the invention. The coating material according to the invention can therefore be applied directly to a freshly produced or cleaned metal strip surface. Furthermore, it is preferable if the coating of the metal strip surface with the composition according to the invention is the only coating. It is therefore neither necessary nor desirable for the metal strip to be overcoated with a further coating after the application and curing of the coating material according to the invention. This is explained by the fact that the desired antiadhesive properties with respect to microorganisms are lost as a result of overcoating.

With the composition according to the invention or the coating method according to the invention, it is possible to treat in particular metal strips which are selected from strips of zinc, steel, galvanized or alloy-galvanized steel, stainless steel or aluminium and its alloys.

Finally, the invention relates to a coated metal strip or a metal sheet cut therefrom which can optionally be shaped and which has a coating which is obtainable by the method described above. As mentioned at the outset, these are in particular components of air conditioning systems or ventilation ducts or are metal strips which are intended for the production of such components.

### EXAMPLES

The following tables present a UV-polymerizable composition of the prior art according to WO 00/69978 as a comparative composition and compositions according to the invention. The tables contain type and amount (in % by weight, based on the sum of all components mentioned) which were mixed with one another for the preparation of the composition according to the invention. The mixing can be effected in the temperature range between room temperature and 100° C. As explained further above, it is to be expected that individual components of the mixture react with one another thereby. This applies in particular to the Ti isopropoxylate which was used as component a) or as a starting component therefor. This will react in the preparation of the mixture with the carboxylic acids likewise present with liberation of isopropanol. If the mixing is carried out at elevated temperature, at least a part of the isopropanol liberated will evaporate. The ready-to-use composition therefore corresponds only approximately to the sum of the individual components used for its preparation. Succinic anhydride, too, can react with the further components and be bound thereby, for example with hydroxyethyl methacrylate.

Metal sheets comprising steel coated by the hot dip method served as a substrate for the coatings. These were first cleaned using a commercial cleaner (Ridoline® 1340, availagle from Henkel KGaA). The compositions which were obtained on mixing together the components according to the following tables were applied to the cleaned metal sheets. The application was effected by means of a roll coater at room temperature in a layer thickness such that, after curing, a coating which consists of 5 μm was obtained. The compositions were each cured twice with UV radiation at a simulated belt speed of 15 m/min. The metal sheets thus coated were investigated, without further overcoating, with regard to corrosion inhibition properties and adhesion of microorganisms. In the tables, the degrees of white rust (WRi) and the degrees of black rust (BRi) after the respective stated test time (h=hours) are indicated. A degree of rusting of 0 means no corrosion, and a degree of rusting of 5 means complete corrosion. The lower the degree of rusting, the less the corrosion.

In addition to the corrosion inhibition tests, adhesion tests for microorganisms (in this case: Staphylococcus aureus) were carried out. For this purpose, metal test specimens coated with said formulations and measuring 2.2×2.2 cm were first disinfected with 70% strength methyl alcohol for 10 minutes and then washed with sterile and distilled water and dried. The test samples thus prepared were overcoated with a microorganism suspension and incubated for 1 hour. Thereafter, the microorganism suspensions were sucked up and the test specimens were washed twice. After transfer to sterile test plates, the test specimens were overcoated with nutrient agar and then incubated for 48 hours at 30° C. The extent of microorganism growth, which indicates the population of the test specimens with microorganisms, is stated in % relative to a test specimen coated with the comparative composition. The microorganism contamination of the test specimen coated with the comparative composition is set at 100%.

The following tables contain the compositions (batch ratios before mixing in % by weight, based on the total amount of the feedstocks) and the test results obtained therewith.

TABLE 1a
Compositions (% by weight, based on mixture batch, cf. description)

| | Comp. Ex. 1 | Ex. 1 | Ex. 2 | Ex. 3 | Ex. 4 | Ex. 5 | Ex. 6 |
|---|---|---|---|---|---|---|---|
| Aromatic urethane | 25.60 | 25.09 | 24.32 | 25.09 | 24.32 | 25.09 | 24.32 |
| acrylate oligomer | | | | | | | |
| Aliphatic urethane | 25.60 | 25.09 | 24.32 | 25.09 | 24.32 | 25.09 | 24.32 |
| acrylate oligomer | | | | | | | |
| Succinic anhydride | 13.9 | 13.64 | 13.22 | 13.64 | 13.22 | 13.64 | 13.22 |
| Hydroxyethyl | 18.1 | 17.72 | 17.18 | 17.72 | 17.18 | 17.72 | 17.18 |
| methacrylate (“HEMA”) | | | | | | | |
| Phosphorylated | 1.32 | 1.29 | 1.26 | 1.29 | 1.26 | 1.29 | 1.26 |
| hydroxyethyl | | | | | | | |
| methacrylate | | | | | | | |
| Ti tetra- | 9.00 | 8.82 | 8.55 | 8.82 | 8.55 | 8.82 | 8.55 |
| isopropoxylate | | | | | | | |
| Ethoxylated (15 EO) | 1.24 | 1.22 | 1.18 | 1.22 | 1.18 | 1.22 | 1.18 |
| trimethylolpropane | | | | | | | |
| Acrylic acid | 0.34 | 0.33 | 0.32 | 0.33 | 0.32 | 0.33 | 0.32 |
| Mixture of 2-hydroxy- | 4.60 | 4.51 | 4.37 | 4.51 | 4.37 | 4.51 | 4.37 |
| 2-methyl-1- | | | | | | | |
| phenylpropanone and | | | | | | | |
| 1-hydroxycyclohexyl | | | | | | | |
| phenyl ketone | | | | | | | |
| Bis(2,4,6-trimethylphenyl)- | 0.30 | 0.29 | 0.28 | 0.29 | 0.28 | 0.29 | 0.28 |
| acylphenylphosphine | | | | | | | |
| oxide | | | | | | | |
| Polyethylene glycol | — | 2.00 | 5.00 | — | — | — | — |
| monoacrylate | | | | | | | |
| 375 g/mol | | | | | | | |
| Polypropylene glycol | — | — | — | 2.00 | 5.00 | — | — |
| monoacrylate | | | | | | | |
| 400 g/mol | | | | | | | |
| Ethoxylated (8 EO) | — | — | — | — | — | 2.00 | 5.00 |
| nonylphenol acrylate | | | | | | | |
| 626 g/mol | | | | | | | |

TABLE 1b
Test results (neutral salt spray test = NSS, degree of white rust
(WRi) and degree of black rust (BRi) after test time in hours (=h))

| NSS | | | Comp. Ex. 1 | | Ex. 1 | | Ex. 2 | | Ex. 3 | | Ex. 4 | | Ex. 5 | | Ex. 6 | |
|---|---|---|---|---|---|---|---|---|---|---|---|---|---|---|---|---|
| 24 | h | WRi BRi | 0 | 0 | 0 | 0 | 0 | 0 | 0 | 0 | 0 | 0 | 0 | 0 | 0 | 0 |
| 48 | h | WRi BRi | 2.0 | 0 | 1.0 | 0 | 1.0 | 0 | 1.0 | 0 | 0 | 0 | 0 | 0 | 1.0 | 0 |
| 72 | h | WRi BRi | 2.0 | 1.0 | 2.0 | 0 | 1.0 | 0 | 1.0 | 0 | 1.0 | 0 | 1.0 | 0 | 1.0 | 0 |
| 96 | h | WRi BRi | 3.0 | 1.0 | 2.0 | 1.0 | 1.0 | 1.0 | 1.0 | 1.0 | 1.0 | 1.0 | 1.0 | 1.0 | 1.0 | 1.0 |
| 120 | h | WRi BRi | 4.0 | 1.0 | 3.0 | 1.0 | 2.0 | 1.0 | 2.0 | 1.0 | 2.0 | 1.0 | 1.0 | 1.0 | 2.0 | 1.0 |
| 144 | h | WRi BRi | 5.0 | 2.0 | 3.0 | 2.0 | 2.0 | 2.0 | 2.0 | 2.0 | 2.0 | 1.0 | 2.0 | 1.0 | 2.0 | 2.0 |

| | | | | | | | | | | | | | | | |
|---|---|---|---|---|---|---|---|---|---|---|---|---|---|---|---|
| 168 | h | WRi BRi | — | 3.0 | 2.0 | 2.0 | 2.0 | 2.0 | 2.0 | 2.0 | 1.0 | 2.0 | 1.0 | 2.0 | 2.0 |
| 192 | h | WRi BRi | — | 3.0 | 3.0 | 3.0 | 2.0 | 3.0 | 2.0 | 2.0 | 2.0 | 2.0 | 1.0 | 3.0 | 2.0 |
| 216 | h | WRi BRi | — | 4.0 | 3.0 | 3.0 | 3.0 | 3.0 | 3.0 | 3.0 | 2.0 | 2.0 | 2.0 | 3.0 | 2.0 |
| 240 | h | WRi BRi | — | 4.0 | 3.0 | 4.0 | 3.0 | 3.0 | 3.0 | 3.0 | 2.0 | 2.0 | 2.0 | 3.0 | 3.0 |
| 264 | h | WRi BRi | — | 5.0 | 3.0 | 4.0 | 3.0 | 4.0 | 3.0 | 4.0 | 2.0 | 3.0 | 2.0 | 4.0 | 3.0 |

| | | | | | | | | | | | | | | |
|---|---|---|---|---|---|---|---|---|---|---|---|---|---|---|
| 288 | h | WRi BRi | — | — | 4.0 | 3.0 | 4.0 | 3.0 | 4.0 | 3.0 | 4.0 | 3.0 | 4.0 | 3.0 |
| 312 | h | WRi BRi | — | — | 5.0 | 3.0 | 5.0 | 3.0 | 5.0 | 3.0 | 5.0 | 3.0 | 5.0 | 3.0 |

| | | | | | | | | | |
|---|---|---|---|---|---|---|---|---|---|
| 336 | h | WRi BRi | — | — | — | — | — | — | — |
| 360 | h | WRi BRi | — | — | — | — | — | — | — |

TABLE 2a
Further compositions (% by weight, based on mixture batch, cf. description)

| | Ex. 7 | Ex. 8 | Ex. 9 | Ex. 10 | Ex. 11 | Ex. 12 |
|---|---|---|---|---|---|---|
| Aromatic urethane | 25.09 | 24.32 | 25.09 | 24.32 | 25.09 | 24.32 |
| acrylate oligomer | | | | | | |
| Aliphatic urethane | 25.09 | 24.32 | 25.09 | 24.32 | 25.09 | 24.32 |
| acrylate oligomer | | | | | | |
| Succinic anhydride | 13.64 | 13.22 | 13.64 | 13.22 | 13.64 | 13.22 |
| Hydroxyethyl methacrylate | 17.72 | 17.18 | 17.72 | 17.18 | 17.72 | 17.18 |
| (“HEMA”) | | | | | | |
| Phosphorylated | 1.29 | 1.26 | 1.29 | 1.26 | 1.29 | 1.26 |
| hydroxyethyl methacrylate | | | | | | |
| Ti tetraisopropoxylate | 8.82 | 8.55 | 8.82 | 8.55 | 8.82 | 8.55 |
| Ethoxylated (15 EO) | 1.22 | 1.18 | 1.22 | 1.18 | 1.22 | 1.18 |
| trimethylolpropane | | | | | | |
| Acrylic acid | 0.33 | 0.32 | 0.33 | 0.32 | 0.33 | 0.32 |
| Mixture of 2-hydroxy-2- | 4.51 | 4.37 | 4.51 | 4.37 | 4.51 | 4.37 |
| methyl-1-phenylpropanone | | | | | | |
| and 1-hydroxycyclohexyl | | | | | | |
| phenyl ketone | | | | | | |
| Bis(2,4,6- | 0.29 | 0.28 | 0.29 | 0.28 | 0.29 | 0.28 |
| trimethylphenyl)- | | | | | | |
| acylphenylphosphine oxide | | | | | | |
| Polyethylene glycol | 2.00 | 5.00 | — | — | — | — |
| diacrylate 408 g/mol | | | | | | |
| Polyethylene glycol | — | — | 2.00 | 5.00 | — | — |
| monoacrylate 336 g/mol | | | | | | |
| Polyethylene glycol | — | — | — | — | 2.00 | 5.00 |
| diacrylate 308 g/mol | | | | | | |

TABLE 2b
Test results for compositions of Table 2a

| NSS | | | Ex. 7 | | Ex. 8 | | Ex. 9 | | Ex. 10 | | Ex. 11 | | Ex. 12 | |
|---|---|---|---|---|---|---|---|---|---|---|---|---|---|---|
| 24 | h | WRi BRi | 0 | 0 | 0 | 0 | 0 | 0 | 0 | 0 | 0 | 0 | 0 | 0 |
| 48 | h | WRi BRi | 1.0 | 0 | 1.0 | 0 | 1.0 | 0 | 1.0 | 0 | 2.0 | 0 | 2.0 | 0 |
| 72 | h | WRi BRi | 1.0 | 0 | 1.0 | 0 | 1.0 | 1.0 | 2.0 | 1.0 | 2.0 | 1.0 | 2.0 | 1.0 |
| 96 | h | WRi BRi | 1.0 | 1.0 | 1.0 | 1.0 | 2.0 | 1.0 | 3.0 | 1.0 | 2.0 | 2.0 | 2.0 | 2.0 |
| 120 | h | WRi BRi | 2.0 | 1.0 | 2.0 | 1.0 | 4.0 | 1.0 | 4.0 | 3.0 | 2.0 | 2.0 | 2.0 | 2.0 |
| 144 | h | WRi BRi | 3.0 | 2.0 | 2.0 | 2.0 | 4.0 | 2.0 | 4.0 | 3.0 | 3.0 | 3.0 | 2.0 | 2.0 |
| 168 | h | WRi BRi | 3.0 | 3.0 | 3.0 | 3.0 | 4.0 | 2.0 | 5.0 | 3.0 | 3.0 | 3.0 | 3.0 | 2.0 |

| | | | | | | | | | | | | | |
|---|---|---|---|---|---|---|---|---|---|---|---|---|---|
| 192 | h | WRi BRi | 4.0 | 3.0 | 3.0 | 3.0 | 4.0 | 2.0 | — | 4.0 | 3.0 | 3.0 | 2.0 |
| 216 | h | WRi BRi | 4.0 | 3.0 | 4.0 | 3.0 | 4.0 | 2.0 | — | 4.0 | 3.0 | 3.0 | 3.0 |
| 240 | h | WRi BRi | 5.0 | 3.0 | 4.0 | 3.0 | 4.0 | 3.0 | — | 4.0 | 3.0 | 4.0 | 3.0 |

| | | | | | | | | | | | | |
|---|---|---|---|---|---|---|---|---|---|---|---|---|
| 264 | h | WRi BRi | — | 5.0 | 3.0 | 4.0 | 3.0 | — | 5.0 | 3.0 | 5.0 | 3.0 |

| | | | | | | | | | |
|---|---|---|---|---|---|---|---|---|---|
| 288 | h | WRi BRi | — | — | 5.0 | 3.0 | — | — | — |

| | | | | | | | | |
|---|---|---|---|---|---|---|---|---|
| 312 | h | WRi BRi | — | — | — | — | — | — |
| 336 | h | WRi BRi | — | — | — | — | — | — |
| 360 | h | WRi BRi | — | — | — | — | — | — |

TABLE 3a
Further compositions (% by weight, based on mixture batch, cf. description)

| | Ex. 13 | Ex. 14 | Ex. 15 | Ex. 16 | Ex. 17 |
|---|---|---|---|---|---|
| Aromatic urethane acrylate | 25.09 | 24.32 | 24.32 | 24.32 | 24.32 |
| oligomer | | | | | |
| Aliphatic urethane acrylate | 25.09 | 24.32 | 24.32 | 24.32 | 24.32 |
| oligomer | | | | | |
| Succinic anhydride | 13.64 | 13.22 | 13.22 | 13.64 | 13.22 |
| Hydroxyethyl methacrylate | 17.72 | 17.18 | 17.18 | 17.72 | 17.18 |
| (“HEMA”) | | | | | |
| Phosphorylated hydroxyethyl | 1.29 | 1.26 | 1.26 | 1.26 | 1.26 |
| methacrylate | | | | | |
| Ti tetraisopropoxylate | 8.82 | 8.55 | 8.55 | 8.55 | 8.55 |
| Ethoxylated (15 EO) | 1.22 | 1.18 | 1.18 | 1.18 | 1.18 |
| trimethylolpropane | | | | | |
| Acrylic acid | 0.33 | 0.32 | 0.32 | 0.32 | 0.32 |
| Mixture of 2-hydroxy-2- | 4.51 | 4.37 | 4.37 | 4.37 | 4.37 |
| methyl-1-phenylpropanone and | | | | | |
| 1-hydroxycyclohexyl phenyl | | | | | |
| ketone | | | | | |
| Bis(2,4,6-trimethylphenyl)- | 0.29 | 0.28 | 0.28 | 0.28 | 0.28 |
| acylphenylphosphine oxide | | | | | |
| Polyethylene glycol | 2.00 | 5.00 | — | — | — |
| monoacrylate 400 g/mol | | | | | |
| Polyethylene glycol methyl | — | — | 5.00 | — | — |
| ether methacrylate 475 g/mol | | | | | |
| Polyethylene glycol methyl | — | — | — | 5.00 | — |
| ethyl methacrylate | | | | | |
| 1100 g/mol | | | | | |
| Polyethylene glycol methyl | — | — | — | — | 5.00 |
| ethyl methacrylate | | | | | |
| 2080 g/mol | | | | | |

TABLE 3b
Test results for Compositions of Table 3a

| NSS | | | Ex. 13 | | Ex. 14 | | Ex. 15 | | Ex. 16 | | Ex. 17 | |
|---|---|---|---|---|---|---|---|---|---|---|---|---|
| 24 | h | WRi BRi | 0 | 0 | 0 | 0 | 0 | 0 | 0 | 0 | 0 | 0 |
| 48 | h | WRi BRi | 2.0 | 0 | 2.0 | 0 | 2.0 | 0 | 2.0 | 0 | 2.0 | 0 |
| 72 | h | WRi BRi | 2.0 | 1.0 | 2.0 | 1.0 | 3.0 | 0 | 2.0 | 0 | 3.0 | 1.0 |
| 96 | h | WRi BRi | 2.0 | 2.0 | 2.0 | 2.0 | 3.0 | 0 | 2.0 | 1.0 | 3.0 | 1.0 |
| 120 | h | WRi BRi | 3.0 | 2.0 | 3.0 | 2.0 | 3.0 | 1.0 | 3.0 | 1.0 | 3.0 | 1.0 |
| 144 | h | WRi BRi | 3.0 | 3.0 | 3.0 | 3.0 | 3.0 | 2.0 | 3.0 | 2.0 | 3.0 | 2.0 |
| 168 | h | WRi BRi | 4.0 | 3.0 | 4.0 | 3.0 | 3.0 | 2.0 | 4.0 | 3.0 | 3.0 | 2.0 |
| 192 | h | WRi BRi | 4.0 | 3.0 | 5.0 | 3.0 | 4.0 | 2.0 | 5.0 | 3.0 | 4.0 | 2.0 |

| | | | | | | | | | | |
|---|---|---|---|---|---|---|---|---|---|---|
| 216 | h | WRi BRi | 4.0 | 3.0 | — | 4.0 | 3.0 | — | 4.0 | 3.0 |
| 240 | h | WRi BRi | 4.0 | 3.0 | — | 5.0 | 3.0 | — | 5.0 | 3.0 |

| | | | | | | | | |
|---|---|---|---|---|---|---|---|---|
| 264 | h | WRi BRi | 5.0 | 3.0 | — | — | — | — |

| | | | | | | | |
|---|---|---|---|---|---|---|---|
| 288 | h | WRi BRi | — | — | — | — | — |
| 312 | h | WRi BRi | — | — | — | — | — |
| 336 | h | WRi BRi | — | — | — | — | — |
| 360 | h | WRi BRi | — | — | — | — | — |

TABLE 4a
Further compositions (% by weight, based on mixture batch, cf. description)

| | Ex. 18 | Ex. 19 | Ex. 20 | Ex. 21 | Ex. 22 | Ex. 23 |
|---|---|---|---|---|---|---|
| Aromatic urethane | 25.09 | 23.04 | 24.58 | 23.81 | 22.53 | 21.76 |
| acrylate oligomer | | | | | | |
| Aliphatic urethane | 25.09 | 23.04 | 24.58 | 23.81 | 22.53 | 21.76 |
| acrylate oligomer | | | | | | |
| Succinic anhydride | 13.64 | 12.53 | 13.36 | 12.94 | 12.25 | 11.83 |
| Hydroxyethyl | 17.72 | 16.27 | 17.35 | 16.81 | 15.91 | 15.36 |
| methacrylate (“HEMA”) | | | | | | |
| Phosphorylated | 1.29 | 1.19 | 1.26 | 1.23 | 1.16 | 1.12 |
| hydroxyethyl | | | | | | |
| methacrylate | | | | | | |
| Ti tetraisopropoxylate | 8.82 | 8.10 | 8.64 | 8.37 | 7.92 | 7.65 |
| Ethoxylated (15 EO) | 1.22 | 1.12 | 1.19 | 1.16 | 1.09 | 1.06 |
| trimethylolpropane | | | | | | |
| Acrylic acid | 0.33 | 0.30 | 0.33 | 0.31 | 0.30 | 0.29 |
| Mixture of 2-hydroxy-2- | 4.51 | 4.14 | 4.42 | 4.28 | 4.05 | 3.91 |
| methyl-1-phenylpropanone | | | | | | |
| and 1-hydroxycyclohexyl | | | | | | |
| phenyl ketone | | | | | | |
| Bis(2,4,6- | 0.29 | 0.27 | 0.29 | 0.28 | 0.26 | 0.26 |
| trimethylphenyl)- | | | | | | |
| acylphenylphosphine | | | | | | |
| oxide | | | | | | |
| Ag-containing zeolite | 2.00 | 10.00 | 2.00 | 2.00 | 10.00 | 10.00 |
| (0.5% by weight of Ag) | | | | | | |
| Polyethylene glycol | — | — | 2.00 | 5.00 | 2.00 | 5.00 |
| monoacrylate 375 g/mol | | | | | | |

TABLE 4b
Test results for Compositions of table 4a

| NSS | | | Ex. 18 | | Ex. 19 | | Ex. 20 | | Ex. 21 | | Ex. 22 | | Ex. 23 | |
|---|---|---|---|---|---|---|---|---|---|---|---|---|---|---|
| 24 | h | WRi BRi | 0 | 0 | 1.0 | 0 | 0 | 0 | 0 | 0 | 1.0 | 0 | 0 | 0 |
| 48 | h | WRi BRi | 1.0 | 0 | 2.0 | 0 | 0 | 0 | 0 | 0 | 2.0 | 0 | 2.0 | 0 |
| 72 | h | WRi BRi | 1.0 | 1.0 | 2.0 | 1.0 | 1.0 | 0 | 1.0 | 0 | 2.0 | 1.0 | 2.0 | 1.0 |
| 96 | h | WRi BRi | 2.0 | 1.0 | 3.0 | 1.0 | 2.0 | 0 | 2.0 | 0 | 3.0 | 1.0 | 2.0 | 2.0 |
| 120 | h | WRi BRi | 3.0 | 1.0 | 4.0 | 1.0 | 2.0 | 1.0 | 2.0 | 1.0 | 4.0 | 2.0 | 3.0 | 2.0 |
| 144 | h | WRi BRi | 3.0 | 2.0 | 4.0 | 2.0 | 3.0 | 1.0 | 3.0 | 2.0 | 5.0 | 3.0 | 4.0 | 3.0 |

| | | | | | | | | | | | | | |
|---|---|---|---|---|---|---|---|---|---|---|---|---|---|
| 168 | h | WRi BRi | 3.0 | 2.0 | 5.0 | 3.0 | 3.0 | 2.0 | 3.0 | 2.0 | — | 4.0 | 3.0 |

| | | | | | | | | | | | | |
|---|---|---|---|---|---|---|---|---|---|---|---|---|
| 192 | h | WRi BRi | 4.0 | 3.0 | — | 3.0 | 2.0 | 3.0 | 2.0 | — | 5.0 | 3.0 |

| | | | | | | | | | | | |
|---|---|---|---|---|---|---|---|---|---|---|---|
| 216 | h | WRi BRi | 4.0 | 3.0 | — | 3.0 | 3.0 | 3.0 | 3.0 | — | — |
| 240 | h | WRi BRi | 5.0 | 3.0 | — | 3.0 | 3.0 | 3.0 | 3.0 | — | — |

| | | | | | | | | | | |
|---|---|---|---|---|---|---|---|---|---|---|
| 264 | h | WRi BRi | — | — | 4.0 | 3.0 | 3.0 | 3.0 | — | — |
| 288 | h | WRi BRi | — | — | 5.0 | 3.0 | 4.0 | 3.0 | — | — |

| | | | | | | | | | |
|---|---|---|---|---|---|---|---|---|---|
| 312 | h | WRi BRi | — | — | — | 5.0 | 3.0 | — | — |

| | | | | | | | | |
|---|---|---|---|---|---|---|---|---|
| 336 | h | WRi BRi | — | — | — | — | — | — |
| 360 | h | WRi BRi | — | — | — | — | — | — |

TABLE 5a
Further compositions (% by weight, based on mixture batch, cf. description)

| | Comp. Ex. 2 | Ex. 24 | Ex. 25 | Ex. 26 | Ex. 27 |
|---|---|---|---|---|---|
| Aromatic urethane acrylate | 25.09 | 24.58 | 23.81 | 25.09 | 24.32 |
| oligomer | | | | | |
| Aliphatic urethane acrylate | 25.09 | 24.58 | 23.81 | 25.09 | 24.32 |
| oligomer | | | | | |
| Succinic anhydride | 13.64 | 13.36 | 12.94 | 13.64 | 13.22 |
| Hydroxyethyl methacrylate | 17.72 | 17.35 | 16.81 | 17.72 | 17.18 |
| (“HEMA”) | | | | | |
| Phosphorylated hydroxyethyl | 1.29 | 1.26 | 1.23 | 1.29 | 1.26 |
| methacrylate | | | | | |
| Ti tetraisopropoxylate | 8.82 | 8.64 | 8.37 | 8.82 | 8.55 |
| Ethoxylated (15 EO) | 1.22 | 1.19 | 1.16 | 1.22 | 1.18 |
| trimethylolpropane | | | | | |
| Acrylic acid | 0.33 | 0.33 | 0.31 | 0.33 | 0.32 |
| Mixture of 2-hydroxy-2- | 4.51 | 4.42 | 4.28 | 4.51 | 4.37 |
| methyl-1-phenylpropanone and | | | | | |
| 1-hydroxycyclohexyl phenyl | | | | | |
| ketone | | | | | |
| Bis(2,4,6-trimethylphenyl)- | 0.29 | 0.29 | 0.28 | 0.29 | 0.28 |
| acylphenylphosphine oxide | | | | | |
| Polyethylene glycol | — | 2.00 | 5.00 | 2.00 | 5.00 |
| monoacrylate 375 g/mol | | | | | |
| Vinyltrimethoxysilane | 1.00 | 1.00 | 1.00 | — | — |
| Ethylene methacrylate | 1.00 | 1.00 | 1.00 | — | — |
| phosphate | | | | | |

TABLE 5b
Test results for compositions of Table 5a

| NSS | | | Comp. Ex. 2 | | Ex. 24 | | Ex. 25 | | Ex. 26 | | Ex. 27 | |
|---|---|---|---|---|---|---|---|---|---|---|---|---|
| 24 | h | WRi BRi | 0 | 0 | 0 | 0 | 0 | 0 | 0 | 0 | 0 | 0 |
| 48 | h | WRi BRi | 0 | 0 | 0 | 0 | 0 | 0 | 1.0 | 0 | 1.0 | 0 |
| 72 | h | WRi BRi | 1.0 | 0 | 0 | 0 | 0 | 0 | 2.0 | 0 | 1.0 | 0 |
| 96 | h | WRi BRi | 1.0 | 1.0 | 0 | 0 | 0 | 0 | 2.0 | 1.0 | 1.0 | 1.0 |
| 120 | h | WRi BRi | 2.0 | 1.0 | 1.0 | 0 | 1.0 | 0 | 3.0 | 1.0 | 2.0 | 1.0 |
| 144 | h | WRi BRi | 2.0 | 2.0 | 1.0 | 1.0 | 1.0 | 0 | 3.0 | 2.0 | 2.0 | 2.0 |
| 168 | h | WRi BRi | 3.0 | 2.0 | 1.0 | 1.0 | 1.0 | 1.0 | 3.0 | 2.0 | 2.0 | 2.0 |
| 192 | h | WRi BRi | 3.0 | 2.0 | 1.0 | 1.0 | 1.0 | 1.0 | 3.0 | 3.0 | 3.0 | 2.0 |
| 216 | h | WRi BRi | 4.0 | 2.0 | 2.0 | 1.0 | 2.0 | 1.0 | 4.0 | 3.0 | 3.0 | 3.0 |
| 240 | h | WRi BRi | 5.0 | 3.0 | 2.0 | 2.0 | 2.0 | 1.0 | 4.0 | 3.0 | 4.0 | 3.0 |

| | | | | | | | | | | | |
|---|---|---|---|---|---|---|---|---|---|---|---|
| 264 | h | WRi BRi | — | 3.0 | 2.0 | 3.0 | 1.0 | 5.0 | 3.0 | 4.0 | 3.0 |

| | | | | | | | | | | |
|---|---|---|---|---|---|---|---|---|---|---|
| 288 | h | WRi BRi | — | 3.0 | 2.0 | 3.0 | 2.0 | — | 4.0 | 3.0 |
| 312 | h | WRi BRi | — | 3.0 | 2.0 | 3.0 | 2.0 | — | 5.0 | 3.0 |

| | | | | | | | | | |
|---|---|---|---|---|---|---|---|---|---|
| 336 | h | WRi BRi | — | 3.0 | 2.0 | 3.0 | 2.0 | — | — |
| 360 | h | WRi BRi | — | 4.0 | 2.0 | 4.0 | 2.0 | — | — |
| 384 | h | WRi BRi | — | 4.0 | 3.0 | 4.0 | 3.0 | — | — |
| 408 | h | WRi BRi | — | 5.0 | 3.0 | 5.0 | 3.0 | — | — |

TABLE 6
Relative adhesion of microorganisms (Staphylococcus aureus),
cf. description. Standard composition “Comparison
1”, set at 100%.

| Composition | Relative adhesion |
|---|---|
| Comparison 1 | 100% |
| Example 2 | 29% |
| Example 15 | 87% |
| Example 17 | 88% |

1. A composition, curable by polymerization to form a cured layer, comprising:
a) at least one metal compound which reacts before and/or during curing of the composition by polymerization with at least one of components b), c) and, where present, d), such that metal from said metal compound is bound in the cured layer, said metal being selected from silicon, titanium, zirconium, manganese, zinc, vanadium, molybdenum and tungsten;
b) at least one monomer or oligomer comprising at least one carboxyl and/or ester group and at least one olefinic double bond and which has no polyether chain of at least five ethylene oxide and/or propylene oxide units;
c) at least one compound comprising a polyether chain of at least five ethylene oxide and/or propylene oxide units and at least one carboxyl or ester group having at least one polymerizable double bond;
d) optionally, at least one polymerization initiator; and
e) optionally, a biocidal active.

2. The composition according to claim 1, comprising component d) at least one free radical polymerization initiator and/or cationic polymerization initiator.

3. The composition according to claim 1, wherein the metal compound a) comprises at least one acetylacetonate, alcoholate, thiolate, amino or amido group bonded to the metal of said metal compound; and said group is replaceable by a carboxyl group, where present on component b), c) or d).

4. The composition according to claim 1, wherein the metal compound a) comprises at least one organic acid group bonded to the metal and comprising at least one polymerizable C═C double bond or C≡C triple bond.

5. The composition according to claim 1, wherein the metal compound a) is selected from compounds of the general formula (II) 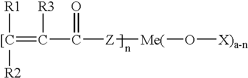
where:
R¹ and R², each independently, is H, C₁- to C₁₂-alkyl, aralkyl or the group —CO—O—Y;
R³ is H or a C₁- to C₁₂-alkyl,
Me is a metal atom having an oxidation state “a”, said metal atom being selected from silicon, titanium, zirconium, manganese, zinc, vanadium, molybdenum and tungsten;
X is H, C₁- to C₁₂-alkyl, aryl, aralkyl, alkoxyl or aroxyl, and optionally 2(-O—X) may be acetylacetonate;
Y is H, C₁- to C₁₂-alkyl or a further metal ion Me;
Z is selected from O, NH₂, O-Z^{b}-C(═O)—O, O-Z^{b}-P(═O)—O, O-Z^{b}-P(═O)₂—O, O-Z^{b}-O—P(═O)—O, O-Z^{b}O—-P(═O)₂—O, O-Z^{b}-S(═O)₂—O, and O-Z^{b}-O—S(═O)₂—O,
where Z b is an organic group; and
n is 0 to “a”, where “a” is the oxidation state of the metal Me in the group -Me(—O—X)ₐ₋ₙ.

6. The composition according to claim 5, wherein the organic group Z^{b} is selected from:
a linear or branched alkylene group (CH₂)ₓ, x being a number in the range from 1 to 10;
(CHR⁴—CHR⁴—O—)_{y}CHR⁴—CHR⁴, wherein each R⁴, independently, is a H or CH₃, and y is a number in the range from 0 to 9; and
(CH₂)ₓ—O—C(═O)—(CH₂)_{y}, wherein each of x and y, independently, is a number in the range from 1 to 10.

7. The composition according to claim 5, wherein, in the general formula (II), at least one of R1, R2 and R3 is selected from H, CH₃, C₂—H₅, C₃H₇ and C₄H₉.

8. The composition according to claim 1, wherein said component b) comprises at least one monomer or oligomer comprising at least one acid group selected from acrylic acid, methacrylic acid, crotonic acid, vinylacetic acid, maleic acid, and fumaric acid groups, wherein optionally all or some of said carboxyl groups are esterified.

9. The composition according to claim 8, wherein said component b) comprises at least one monomer or oligomer selected from aromatic or aliphatic urethane acrylate or urethane methacrylate oligomers and adducts or copolymers of acrylic acid or methacrylic acid or hydroxyalkyl derivatives thereof with unsaturated dicarboxylic acids or with anhydrides of polybasic carboxylic acids or derivatives thereof.

10. The composition according to claim 1, wherein the compound of group c) has a molar mass in the range from 250 to 2500 grams.

11. The composition according to claim 1, comprising as component e) a biocidal active.

12. The composition according to claim 11, wherein the biocidal active is an organic compound which is bound in the cured layer.

13. The composition according to claim 11, wherein the biocidal active is a particulate inorganic compound or a particulate metal.

14. The composition according to claim 11, wherein the biocidal active comprises biocidal metal ions which are bound to an organic or inorganic skeleton capable of cation exchange and are exchangeable for alkali metal ions.

15. The composition according to claim 14, wherein the biocidal active comprises metal cations which are selected from tin, zinc, copper and silver ions.

16. The composition according to claim 1, comprising amounts of components a)-e), based on the total composition of:
component a): from 2 to 49.99% by weight,
component b): from 50 to 90% by weight,
component c): from 0.01 to 20% by weight,
component d): from 0 to 10% by weight,
component e): from 0 to 15% by weight.

17. The composition according to claim 16, wherein the amount of the components a) to e) sum to at least 80% by weight of the total composition, and the composition comprises not more than 20% by weight of further components.

18. The composition according to claim 1, wherein the composition comprises not more than 10% by weight, of further components selected from adhesion promoters and corrosion inhibitors.

19. The composition according to claim 1, comprising not more than 10% by weight of components which are not incorporated into the cured layer during curing by polymerization.

20. A method for coating of a metal strip, comprising:
a) applying the composition according to claim 1, to a surface of a metal strip thereby forming an uncured layer; and
b) curing said layer by irradiation with high-energy radiation thereby forming a coated metal strip;
wherein the uncured layer is applied at a thickness such that, after curing, a cured layer in the range from 1 to 10 μm thick is obtained.

21. The method according to claim 20, wherein the metal strip surface is subjected to no other corrosion inhibition treatment before step a), and is not overcoated with a further coating after step b).

22. The method according to claim 20, wherein the metal strip is selected from strips of zinc, steel, galvanized or alloy-galvanized steel, stainless steel or aluminium and its alloys.

23. A coated metal strip or metal sheet cut therefrom, which can optionally be shaped, coated according to the method of claim 20.
